(19) United States
(12) Patent Application Publication
(10) Pub. No.: US 2006/0105140 A1
(43) Pub. Date: May 18, 2006

(54) Mask for plugging particulate filter cells

(76) Inventors: Edward F. Andrewlavage JR., Corning, NY (US); David J. Worthey, Elmira, NY (US)

Correspondence Address: CORNING INCORPORATED, SP-TI-3-1, CORNING, NY, 14831, US

(21) Appl. No.: 10/990,109

(22) Filed: Nov. 15, 2004

(51) Int. Cl. B32B 3/10; B32B 37/00

(52) U.S. Cl. 428/131; 156/250; 156/272.8

(57) ABSTRACT

A mask for plugging cells in a monolith body includes a planar sheet having a cell mask region bordered by a skin mask region. The cell mask region includes a plurality of openings through which a filler material can be injected into selected cells in the monolith body. The planar sheet has a size such that when it is mounted on an end face of the monolith body, the cell mask region overlaps the cells in the end face of the monolith body and the skin mask region extends laterally past a periphery of the monolith body.

### BACKGROUND OF INVENTION

Wall-flow particulate filters are used to remove carbonaceous soot from exhaust emitted by diesel engines and other internal combustion engines. FIG. 1 shows an example of a wall-flow particulate filter 100 having a monolith body 102, which is typically extruded from a ceramic material such as cordierite or silicon carbide. The monolith body 102 has a skin 104. Within the skin 104 are interconnecting porous walls 106, which define longitudinal channels 108a, 108b inside the monolith body 102. The monolith body 102 has an inlet end face 110 and an outlet end face 112. At the inlet end face 110, the channels 108a are plugged with filler material. At the outlet end face 112, the channels 108b are plugged with filler material. The ends of the channels 108a,108b are selectively plugged with filler material by applying masks (not shown) to the end faces 110, 112 of the monolith body 102 and injecting filler material through openings in the masks into selected cells at the end faces 110, 112. In operation, exhaust enters the monolith body 102 through the inlet channels 108b, passes from the channels 108b through the porous walls 106 into the outlet channels 108a, and exits the monolith body 102 through the channels 108a.

U.S. Pat. No. 4,557,773 (issued to Bonzo) describes an automated method for selectively plugging cells at the end faces of a monolith body. The method involves applying a thin transparent polymer film to an end face of a monolith body and scanning the film to generate signals indicative of the location of the cells beneath the film. The cell location signals are then used to position a tool to create openings through the film at selected cell locations. The polymer film is wrapped around the end face of the monolith body such that the mask is fitted to the end face of the monolith body. This creates a situation where the filler material can flow over the mask and down the side of the monolith body as it is injected through the openings in the mask. Filler material on the side of the monolith body results in a side smear defect, which is difficult to manage if the final product requires an as-extruded skin. Side smear defect may be avoided by pneumatically sealing around the periphery of the monolith body prior to injecting the filler material through the openings in the mask. However, this solution increases the cost of producing the filter and limits masking and plugging to one monolith body at a time.

### SUMMARY OF INVENTION

In one aspect, the invention relates to a mask for plugging cells in a monolith body which comprises a planar sheet having a cell mask region bordered by a skin mask region. The cell mask region includes a plurality of openings through which a filler material can be injected into selected cells in the monolith body. The planar sheet has a size such that when it is mounted on an end face of the monolith body, the cell mask region overlaps the cells in the end face of the monolith body and the skin mask region extends laterally past a periphery of the monolith body.

In another aspect, the invention relates to a mask for plugging cells in multiple honeycomb bodies which comprises a planar sheet having multiple cell mask regions bordered by a skin mask region. Each of the cell mask regions includes a plurality of openings through which a filler material can be injected into selected cells in one of the multiple honeycomb bodies. The planar sheet has a size such that when it is mounted on the end faces of the multiple honeycomb bodies, the cell mask regions overlap the cells in the end faces of the multiple honeycomb bodies and the skin mask region extends laterally from a periphery of the multiple honeycomb bodies.

In yet another aspect, the invention relates to a method of plugging cells in a monolith body which comprises applying a planar sheet to an end face of a monolith body such that the planar sheet extends laterally past a periphery of the monolith body, scanning the planar sheet and generating signals indicative of the location of cells on the end face, and cutting openings in the planar sheet opposite selected cell locations.

In another aspect, the invention relates to a method of plugging cells in multiple honeycomb bodies which comprises applying a planar sheet across the end faces of multiple honeycomb bodies such that the planar sheet extends laterally past a periphery of the honeycomb bodies, scanning the planar sheet and generating signals indicative of the location of cells on the end faces, and cutting openings in the planar sheet opposite selected cell locations.

Other features and advantages of the invention will be apparent from the following description and the appended claims.

### BRIEF DESCRIPTION OF DRAWINGS

FIG. 1 shows a prior-art honeycomb filter.

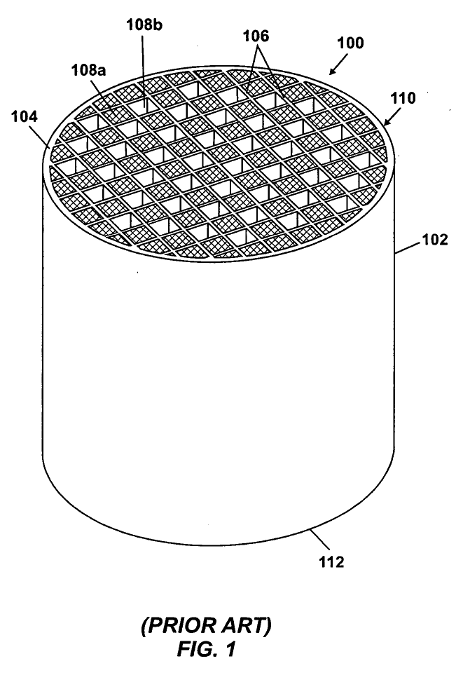

FIG. 2A is a top view of a mask according to one embodiment of the invention.

FIG. 2B shows the mask of FIG. 2A supported by a frame.

FIG. 3 shows a monolith body before plugging.

FIG. 4A shows the mask of FIG. 2A suspended above the monolith body of FIG. 3.

FIG. 4B shows a piston injecting filler material through a mask according to an embodiment of the invention into cells in a monolith body.

FIG. 5 illustrates a vision-guided laser cutting process for forming a mask according to an embodiment of the invention.

FIG. 6 shows a mask for selectively plugging cells in multiple honeycomb bodies according to another embodiment of the invention.

### DETAILED DESCRIPTION OF PREFERRED EMBODIMENTS

The invention will now be described in detail with reference to a few preferred embodiments, as illustrated in accompanying drawings. In the following description, numerous specific details are set forth in order to provide a thorough understanding of the invention. However, it will be apparent to one skilled in the art that the invention may be practiced without some or all of these specific details. In other instances, well-known features and/or process steps have not been described in detail in order to not unnecessarily obscure the invention. The features and advantages of the invention may be better understood with reference to the drawings and discussions that follow.

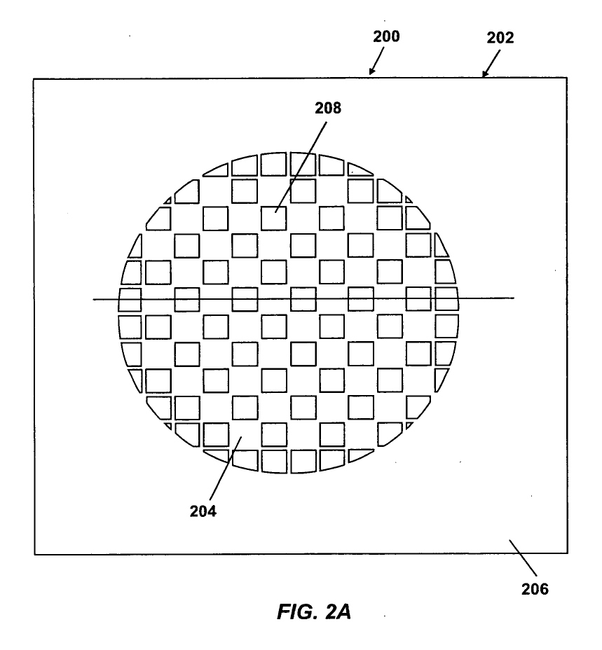

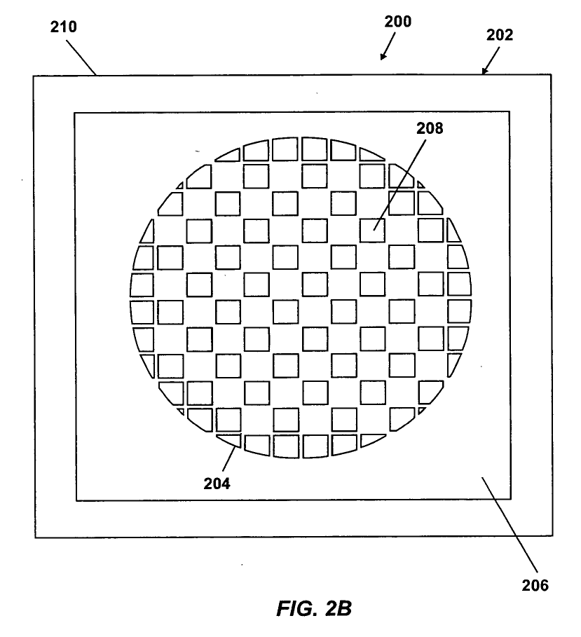

FIG. 2A illustrates a mask 200 for selectively plugging cells in an end face of a monolith body according to one embodiment of the invention. The mask 200 includes a planar sheet 202 having a cell mask region 204 bordered by a skin mask region 206. The cell mask region 204 includes a plurality of openings 208. In this embodiment, the openings 208 are shown as having a square geometry. The corners of the square could include fillets, or the openings 208 may have other geometry besides square, e.g., circle or triangle. Typically, the geometry of the openings 208 would be dictated by the geometry of the cells in the monolith body to which the mask 200 would be applied. Also, the number and size of the openings 208 would be dictated by the number and size of the cells to be plugged in the end face of the monolith body. The planar sheet 202 may be self-supporting, or the edges of the planar sheet 202 may be secured in a support frame (e.g., frame 210 in FIG. 2B). The planar sheet 202 may be made of a wide variety of materials, e.g., polymer (e.g., polyester), elastomer (e.g., silicone), or metal.

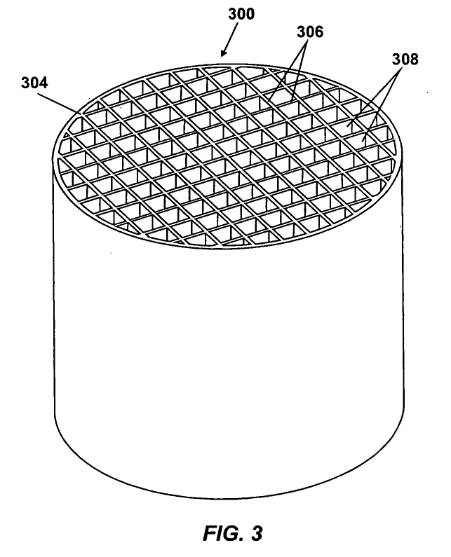

For illustration purposes, FIG. 3 shows a monolith body 300 having cells that can be selectively plugged by the mask (200 in FIG. 2A). The monolith body 300 is columnar and has a cross-sectional shape defined by a skin (or peripheral wall) 304. The profile of the skin 304 is typically circular or elliptical, but the invention is not limited to any particular skin profile. The monolith body 300 has an array of interconnecting porous walls 306 intersecting with the skin 304. The porous walls 306 define a grid of channels 308 extending longitudinally along the length of the monolith body 300. The cross-section of the channels (or cells) 308 may be square as shown or may have other shape. Typically, the monolith body 300 is made by extrusion. Typically, the extrusion material is a ceramic material, such as cordierite or silicon carbide, but could also be glass, glass-ceramic, plastic, or metal. The thickness and porosity of the porous walls 306 are such that the structural integrity of the monolith body 300 is not compromised. For diesel exhaust filtration, the porous walls 306 may incorporate pores having mean diameters in the range of 1 to 60 μm, more preferably in a range from 10 to 50 μm.

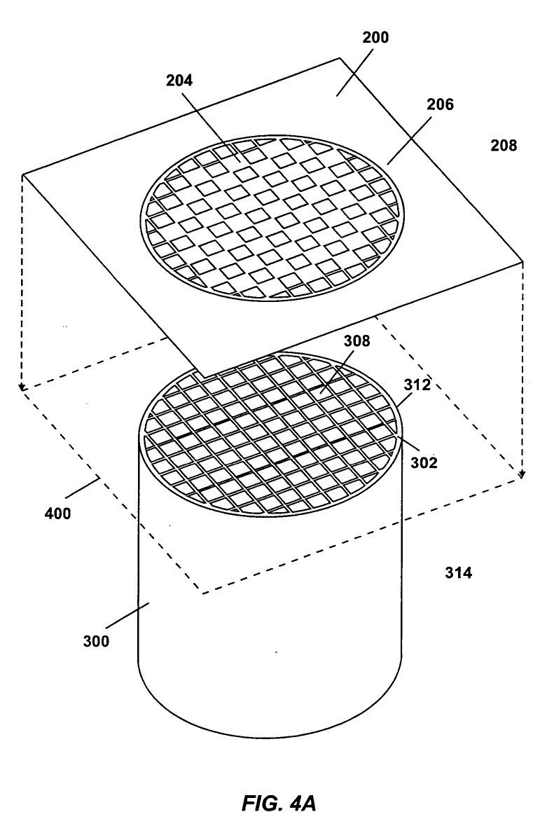

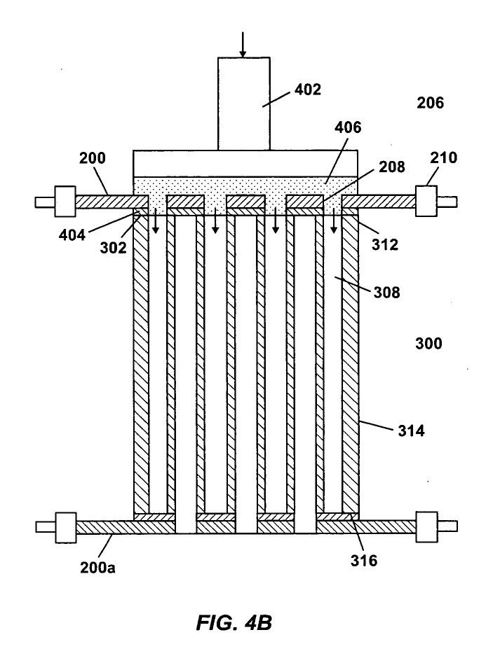

FIG. 4A shows the mask 200 suspended above the monolith body 300. The phantom line 400 shows where the mask 200 would be when applied on an end face 302 of the monolith body 300. When the mask 200 is applied on the end face 302 of the monolith body 300, the cell mask region 204 overlaps the cells 308 on the end face 302 of the monolith body 300 and the skin mask region 206 overlaps the skin 314 of the monolith body 300. In this position, the openings 208 in the cell mask region 204 are aligned with selected cells 308 on the end face 302 of the monolith body 300. From the end face 302, the cells 308 aligned with the openings 208 can be filled with filler material through the openings 208. The skin mask region 206 is oversized such that when the mask 200 is applied on the end face 302 of the monolith body 300 as described above, the skin mask region 206 covers the skin 314 and extends laterally past the periphery 312 of the monolith body 300.

FIG. 4B shows a piston 402 injecting filler material 406 into selected cells 308 in the end face 302 of the monolith body 300 through the openings 208 in the mask 200. The piston 402 may be manually operated or may be part of a press apparatus as taught in, for example, U.S. Pat. No. 4,557,773 (issued to Bonzo). The filler material 406 is preferably a flowable material. The filler material 406 may be a mixture of a ceramic raw material with a binder and a plasticizer. While the filler material 406 is injected into the selected cells 308 in the end face 302 of the monolith body 300, the skin mask region 206, which extends laterally past the periphery 312 of the monolith body 300, prevents the filler material 406 from flowing down the side 314 of the monolith body 300. Thus, the monolith body 300 is free of side smear defect after injecting the filler material 406 into the selected cells. The mask 200 is preferably secured to the end face 302 of the monolith body 300 by an adhesive layer 404. While the filler material 406 is injected into the selected cells 308 in the monolith body, the adhesive layer 404 may also prevent the filler material 406 from getting squeezed in between the mask 200 and the end face 302 of the monolith body. A mask 200a similar to mask 200 can be applied to the opposite end face 316 of the monolith body 300 to allow selective plugging of cells on the end face 316. A double-headed press apparatus may be used to plug the cells in the monolith body simultaneously.

In one embodiment, the planar sheet 200 is a thin transparent film, e.g., a thin transparent polymer film, e.g., a thin transparent polyester film. The transparent film may be self-supporting. However, if the transparent film is not self-supporting, support of the transparent film would be required, e.g., the edges of the transparent film could be secured in a frame as previously described in FIG. 2B. The transparent film may have an adhesive backing that will serve as the adhesive layer 404 described above. The thin transparent film allows use of a vision-guided laser cutting process similar to the one described in U.S. Pat. No. 4,557,773 (issued to Bonzo), the disclosure of which is incorporated herein by reference, to be used in making the mask 200. A vision-guided laser cutting process according to an embodiment of the invention includes applying thin transparent films on both end faces of the monolith body, capturing and analyzing the end faces of the monolith body through the films, generating laser targeting information, and commanding a laser to burn openings in the film to create the masks.

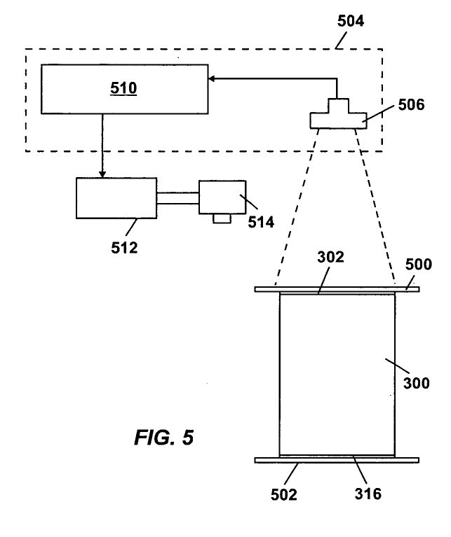

FIG. 5 illustrates the vision-guided laser cutting process. In FIG. 5, thin transparent films 500, 502 have been applied to the end faces 302, 316 of the monolith body 300. The thin transparent films 500, 502 are oversized in order to provide a skin mask region that extends laterally past the periphery of the monolith body as previously described. An optical image analyzer 504 is positioned above the transparent film 500. The optical image analyzer 504 includes an optical device 506, e.g., a camera, that scans the transparent film 500 and generates signals indicating the location of the cells and/or porous walls (308, 306 in FIG. 3) forming the cells beneath the film 500. The optical image analyzer 504 includes a processor 510 that turns the signals generated by the camera 506 into laser target information. The laser target information is used to control a precision actuator 512 to position a laser source 514 to create openings through the film 500 at selected cell locations. The process just described for the transparent film 500 is repeated for the transparent film 502. A second set of optical image analyzer, precision actuator, and laser source can allow simultaneous scanning of and creation of openings in both transparent films 500, 502.

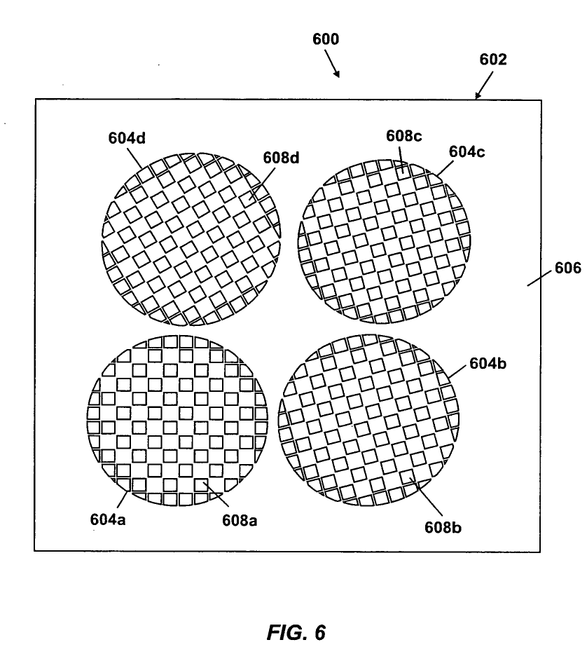

FIG. 6 shows a mask 600 for selectively plugging cells in end faces of multiple honeycomb bodies according to an embodiment of the invention. In this example, the mask 600 can be used to selectively plug cells in four honeycomb bodies (not shown). The mask 600 includes a planar sheet 602 having cell mask regions 604a, 604b, 604c, 604d bordered by a skin mask region 606. The cell mask regions 604a, 604b, 604c, 604d have openings 608a, 608b, 608c, 608d, respectively. When the mask 600 is applied to the honeycomb bodies, the cell mask regions 604a, 604b, 604c, 604d overlap cells in the end faces of the honeycomb bodies. The configuration of the openings 608a, 608b, 608c, 608d in each of the cell mask regions 604a, 604b, 604c, 604d is tailored to the cell pattern in the end face of the monolith body to which the cell mask region would be applied. Therefore, mask 600 can be used to plug honeycomb bodies having different cell geometries.

The mask 600 can be made using the vision-guided laser cutting process described above. That is, thin transparent films can be applied to the inlet and outlet end faces of multiple honeycomb bodies. The inlet and outlet end faces of the multiple honeycomb bodies can be scanned through the transparent films. Then, the scanned information can be used to generate laser targeting information that would be used to control a laser to burn holes in the transparent films. For this method, the length of the honeycomb bodies should be the same. It may be helpful to secure the honeycomb bodies in a tray so that the spatial relationship between the honeycomb bodies is maintained throughout the masking and plugging process.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A mask for plugging cells in a monolith body comprising:
a planar sheet having a cell mask region bordered by a skin mask region, the cell mask region including a plurality of openings through which a filler material can be injected into selected cells in the monolith body, the planar sheet having a size such that when it is mounted on an end face of the monolith body, the cell mask region overlaps the cells in the end face of the monolith body and the skin mask region extends laterally past a periphery of the monolith body and the planar sheet is supported in a frame.

2. The mask of claim 1, wherein the planar sheet is a transparent film.

3. The mask of claim 2, wherein the planar sheet is a transparent polymer film.

4. The mask of claim 2, wherein an adhesive layer is formed on a side of the planar sheet.

5. (canceled)

6. (canceled)

7. A mask for plugging cells in multiple honeycomb bodies comprising:
a planar sheet having multiple cell mask regions bordered by a skin mask region each of the cell mask regions including a plurality of openings through which a filler material can be injected into selected cells in one of the multiple honeycomb bodies, the planar sheet having a size such that when it is mounted on the end faces of the multiple honeycomb bodies, the cell mask regions overlap the cells in the end faces of the multiple honeycomb bodies and the skin mask region extends laterally past a periphery of the multiple honeycomb bodies.

8. The mask of claim 7, wherein the planar sheet is a transparent film.

9. The mask of claim 8, wherein the planar sheet is a transparent polymer film.

10. The mask of claim 8, wherein an adhesive layer is formed on a side of the planar sheet.

11. The mask of claim 7, wherein the planar sheet is self-supporting.

12. The mask of claim 7, wherein the planar sheet is supported in a frame.

13. A method of plugging cells in a monolith body, comprising:
applying a planar sheet to an end face of a monolith body such that the planar sheet extends laterally past a periphery of the monolith body and the planar sheet is supported in a frame;
scanning the planar sheet and generating signals indicative of the location of cells on the end face; and
cutting openings in the planar sheet opposite selected cell locations.

14. (canceled)

15. (canceled)

16. (canceled)

17. A method of plugging cells in multiple honeycomb bodies, comprising:
applying a planar sheet across the end faces of multiple honeycomb bodies such that the planar sheet extends laterally past a periphery of the honeycomb bodies;
scanning the planar sheet and generating signals indicative of the location of cells on the end faces; and
cutting openings in the planar sheet opposite selected cell locations.

18. The method of claim 17, further comprising injecting a filler material into the selected cell locations through the openings.

19. The method of claim 17, wherein applying the planar sheet comprises adhering the planar sheet to the end faces of the multiple honeycomb bodies.

20. (canceled)

21. A mask for plugging cells in a monolith body, comprising:
a planar sheet wherein the edges of the planar sheet are secured in a support frame.

22. The mask of claim 21, wherein the planar sheet includes a cell mask region bordered by a skin mask region, the cell mask region including a plurality of openings through which a filler material can be injected into selected cells in the monolith body, the planar sheet having a size such that when it is mounted on an end face of the monolith body, the cell mask region overlaps the cells in the end face of the monolith body and the skin mask region extends laterally past a periphery of the monolith body.
